(19) United States
(12) Patent Application Publication
(10) Pub. No.: US 2013/0021264 A1
(43) Pub. Date: Jan. 24, 2013

(54) ELECTRONIC DEVICE INCLUDING A TOUCH-SENSITIVE DISPLAY AND NAVIGATION DEVICE AND METHOD OF CONTROLLING SAME

(71) Applicant: Benny Joe CHACKO, Raleigh, NC (US)

(72) Inventor: Benny Joe CHACKO, Raleigh, NC (US)

(73) Assignee: RESEARCH IN MOTION LIMITED, Waterloo (CA)

(21) Appl. No.: 13/187,886

(22) Filed: Jul. 21, 2011

(51) Int. Cl. G06F 3/041

(52) U.S. Cl. 345/173

(57) ABSTRACT

A method includes detecting a touch beginning at a first location on a touch-sensitive display of a portable electronic device, wherein the touch-sensitive display has a first area and second area. The method also includes, when the touch begins, filtering touch data comprising further processing the touch data when the first location is associated with the first area, and disregarding the touch data associated with the touch when the first location is associated with the second area.

### FIELD OF TECHNOLOGY

The present disclosure relates to electronic devices including but not limited to portable electronic devices having touch-sensitive displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones, wireless PDAs, and laptop computers with wireless 702.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed.

Improvements in devices with touch-sensitive displays are desirable.

### BRIEF DESCRIPTION OF THE DRAWINGS

FIG. 1 is a block diagram of a portable electronic device in accordance with the present disclosure.

FIG. 2 is a front view of an example of a portable electronic device in accordance with the disclosure.

FIG. 3 is a flowchart illustrating a method of filtering touches on a touch-sensitive display in accordance with the disclosure.

FIG. 4 through FIG. 8 illustrate examples of touch locations on a touch-sensitive display of the portable electronic device in accordance with the disclosure.

### DETAILED DESCRIPTION

The following describes an electronic device and method including detecting a touch beginning at a first location on a touch-sensitive display of a portable electronic device, wherein the touch-sensitive display has a first area and second area. The method also includes, when the touch begins, filtering touch data comprising further processing the touch data when the first location is associated with the first area, and disregarding the touch data associated with the touch when the first location is associated with the second area.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, such as a portable electronic device as described herein. Examples of electronic devices include mobile, or handheld, wireless communication devices such as pagers, cellular phones, cellular smart-phones, wireless organizers, personal digital assistants, wirelessly enabled notebook computers, tablet computers, mobile internet devices, and so forth. The electronic device may be a portable electronic device without wireless communication capabilities, such as a handheld electronic game, digital photograph album, digital camera, media player, e-book reader, and so forth.

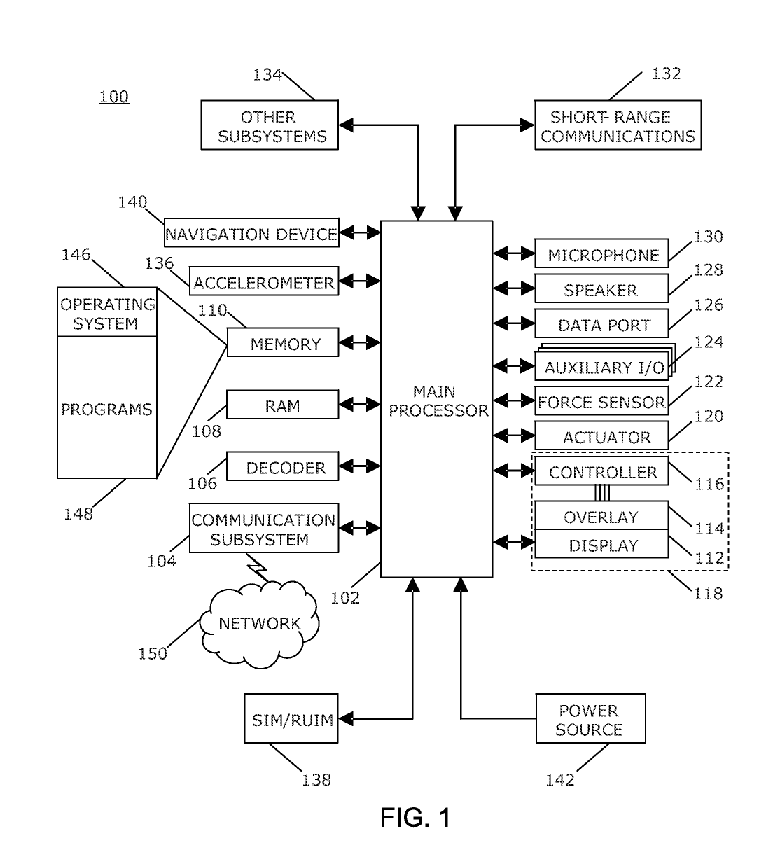

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with a touch-sensitive overlay 114 operably coupled to an electronic controller 116 that together comprise a touch-sensitive display 118, an auxiliary input/output (I/O) subsystem 124, a data port 126, a speaker 128, a microphone 130, short-range communications 132, and other device subsystems 134. User-interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces. Optionally, the processor 102 may interact with one or more actuators 120 and/or one or more force sensors 122.

The processor 102 also interacts with a navigation device 140 such as a touch-sensitive track pad, a trackball, an optical joystick, and so forth, to interface with a user to provide input. The navigation device 140 may be utilized, for example, to navigate or scroll through information on a display, control a cursor or other indicator, edit information, and so forth. In the examples shown, the navigation device 140 is located near the touch-sensitive display 118. “Input” as utilized hereinafter refers to gestures or other contact applied to the navigation device 140 or the interpretation of the gesture or contact by the navigation device 140.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal, such as a text message, an e-mail message, or web page download, is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display 118. The processor 102 may determine attributes of the touch, including a location of a touch. Touch location data may include an area of contact or a single point of contact, such as a point at or near a center of the area of contact. When a touch begins, one or more signals are provided to the controller 116 and the origin of the touch may be determined from the signals. The origin may be a point or an area, for example. Signals may be provided to the controller at regular intervals in time for a touch, also known as sampling, such that changes in location of the touch may be detected. A touch may be detected from any suitable input member, such as a finger, thumb, appendage, or other objects, for example, a stylus, pen, or other pointer, depending on the nature of the touch-sensitive display 118. The controller 116 and/or the processor 102 may detect a touch by any suitable input member on the touch-sensitive display 118. Multiple simultaneous touches may be detected.

One or more gestures may also be detected by the touch-sensitive display 118. A gesture, such as a swipe, also known as a flick, is a particular type of touch on a touch-sensitive display 118 that begins at an origin point and continues to an end point. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A hover may be a touch at a location that is generally unchanged over a period of time or is associated with the same selection item for a period of time.

The optional actuator(s) 120 may be depressed by applying sufficient force to the touch-sensitive display 118 to overcome the actuation force of the actuator 120. The actuator 120 may be actuated by pressing anywhere on the touch-sensitive display 118. The actuator 120 may provide input to the processor 102 when actuated. Actuation of the actuator 120 may result in provision of tactile feedback.

The optional force sensor(s) 122 may provide force information related to a detected touch. The force information may be utilized to select information, such as information associated with a location of a touch. For example, a touch that does not meet a force threshold may highlight a selection option, whereas a touch that meets a force threshold may select or input that selection option. Selection options include, for example, displayed or virtual keys of a keyboard; selection boxes or windows, e.g., “cancel,” “delete,” or “unlock” function buttons, such as play or stop on a music player; and so forth. Different magnitudes of force may be associated with different functions or input. For example, a lesser force may result in panning, and a higher force may result in zooming.

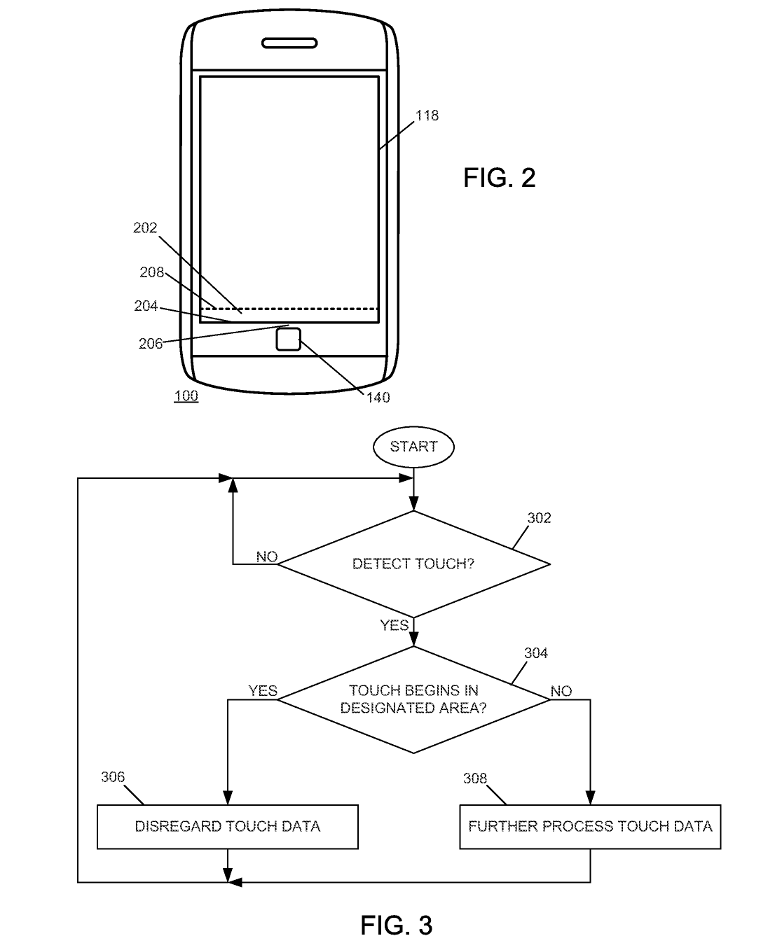

A front view of an example of the electronic device 100 is shown in FIG. 2. The electronic device 100 includes a housing in which the touch-sensitive display 118 and the navigation device 140 are disposed. The housing and the touch-sensitive display 118 encloses components such as the components shown in FIG. 1.

The navigation device 140 is located near an edge 204 of the touch-sensitive display 118. In the orientation illustrated in FIG. 2, the navigation device 140 is located near the bottom edge 204 of the touch-sensitive display 118 and only a thin strip 206 of the housing extends between the navigation device 140 and the touch-sensitive display 118. The terms bottom, left, right, top, upward, and downward, are utilized to provide reference to the orientation of the electronic device in the figures and are not otherwise limiting.

A gesture such as a scrolling gesture on the navigation device 14 may inadvertently touch the touch-sensitive display. A scrolling gesture, on the navigation device 140, that is in the direction of the touch-sensitive display 118 may be detected by the navigation device 140 and subsequently detected by the touch-sensitive display 118. In this example, the portable electronic device 118 receives a scrolling input utilizing the navigation device 140, and, after the scrolling input, the touch begins on the touch-sensitive display 118. A scrolling gesture, on the navigation device 140, that is in the direction away from the touch-sensitive display 118 may be detected by the touch-sensitive display 118 and subsequently detected the navigation device 140.

A predetermined area 202 of the touch-sensitive display 118 may be utilized to determine when to filter touches on the touch-sensitive display 118. The predetermined area 202 of the touch-sensitive display 118 may be a band or strip that is near the navigation device 140. For example, the area may be an area between the edge 204 of the touch-sensitive display 118 and a line 208 spaced from the edge 204 by a distance. The distance may be a measured distance, e.g., 2 mm or 5 mm, or number of pixels such as 10 pixels. The area may extend the full length of the edge 204, from one side of the touch-sensitive display 118 to an opposing side of the touch-sensitive display 118. Alternatively, the area may extend only partially along the edge 204. The size of the predetermined area 202 may be based on the distance of the navigation device 140 from the edge 204 of the touch-sensitive display 118. A larger area may be utilized for an electronic device that includes a navigation device that is very close to the closest edge of the touch-sensitive display. A comparatively smaller area may be utilized for an electronic device that includes a navigation device that is farther from the closest edge of the touch-sensitive display.

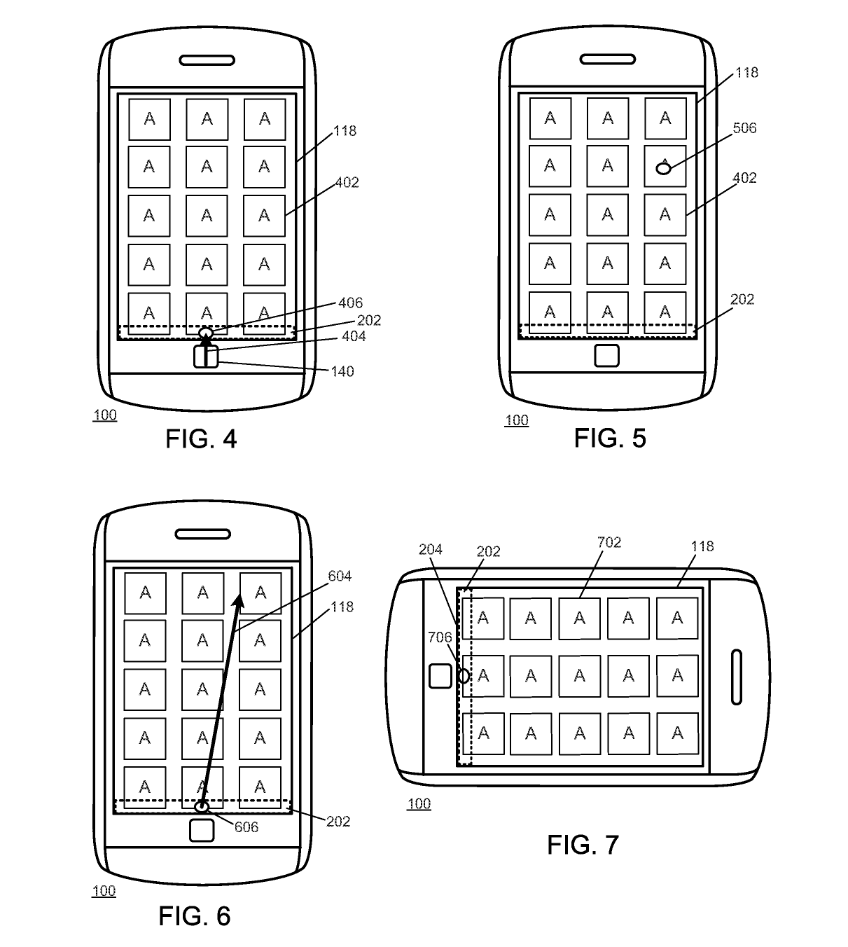

A flowchart illustrating a method of filtering touches on the touch-sensitive display 118 of the electronic device 100 is shown in FIG. 3. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

The process may be carried out when any suitable information is displayed on the touch-sensitive display 118, and through which a user may navigate or scroll and/or make selections. The information may include a list, a document, an index, a menu, and so forth. For example, suitable information includes a menu, or information associated with a suitable application, such as, email, text messaging, calendar, tasks, address book, or any other suitable application.

A touch on the touch-sensitive display 118 is detected 302. The touch may be associated with a selectable feature, such as a key, box, or menu item, displayed on the touch-sensitive display 118. The touch is detected when the touch begins on the touch-sensitive display. The touch may be initiated on another part of the device, such as the housing or on the navigation device 140. The touch does not begin on the touch-sensitive display 118 until the touch is first detected on the touch-sensitive display 118, however. The first detected touch location on the touch-sensitive display 118 is referred to herein as the origin on the touch-sensitive display 118. A touch is associated with an area or a displayed feature when the touch location or a part of the touch location coincides with at least part of the area or at least part of the displayed feature.

When the touch is detected 302, the origin of the touch is utilized to determine whether or not to filter the touch data associated with the touch. When the origin of the touch on the touch-sensitive display 118 is associated with the predetermined area at 304, the touch data is disregarded 306. The touch data, including the origin of the touch on the touch-sensitive display 118 and all touch data received after first detecting the touch, is disregarded. The touch data is not utilized by the application associated with the information displayed on the touch-sensitive display 118. When the origin of the touch on the touch-sensitive display 118 is not associated with the predetermined area at 304, the touch data is further processed 308. The touch data may be further processed by utilizing the touch as input. The touch data may be reported to the application layer, for example.

The determination of whether or not to filter the touch data is made when the touch is first detected on the touch-sensitive display 118, and is not delayed until further touch data is received. The origin of the touch on the touch-sensitive display 118 is disregarded and all other touch data that is received subsequent to detecting the touch at the origin on the touch-sensitive display 118 is disregarded upon receipt.

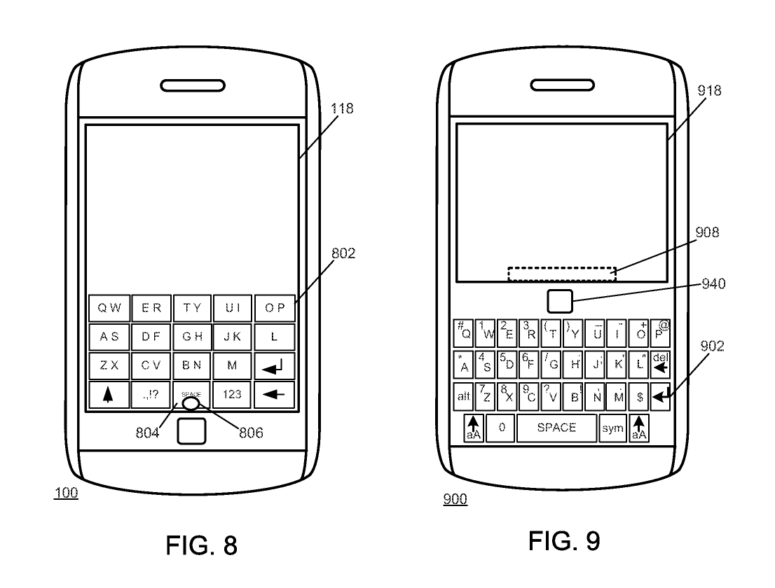

Examples of touches on the touch-sensitive display 118 of the portable electronic device 100 are illustrated in FIG. 4 through FIG. 7. A gesture along the navigation device 140 may be utilized, for example, to scroll through displayed information, such as a list of email messages. For example, a gesture in a direction away from the touch-sensitive display 118 causes downward scrolling through the information, and a gesture in a direction toward the touch-sensitive display 118 causes upward scrolling through the information. For example, when scrolling quickly, a user may inadvertently touch the touch-sensitive display 118, either before scrolling utilizing the navigation device 140 or after scrolling utilizing the navigation device 140, depending on the direction of scrolling.

In the example of FIG. 4, selectable features such as icons 402 are displayed on the touch-sensitive display 118. An example of a gesture along the navigation device 140 is illustrated by the arrow 404. The touch continues from the navigation device 140 to the touch-sensitive display 118 and the touch is first detected at the origin illustrated by the ellipse 406 on the touch-sensitive display 118. The origin on the touch-sensitive display 118 is associated with the predetermined area 202 and all touch data associated with the touch is disregarded.

An example of a touch location on the touch-sensitive display 118 is illustrated by the ellipse 506 in FIG. 5. The touch is detected at the touch location 506 on the touch-sensitive display 118. The touch is associated with an area of the touch-sensitive display 118, which area is not associated with the predetermined area 202. The touch is further processed by, for example, selecting the one of the icons 402 associated with the touch.

In the example illustrated in FIG. 6, a touch is first detected at the touch location illustrated by the ellipse 606 on the touch-sensitive display 118. The touch is associated with the predetermined area 202 and all touch data associated with the touch is disregarded. In the example illustrated in FIG. 6, the touch is a gesture that continues along the path illustrated by the arrow 604. The touch data is disregarded when the touch is first detected on the touch-sensitive display 118. Further touch data is also disregarded as the touch continues along the path illustrated by the arrow 604.

In the example illustrated in FIG. 7, the touch-sensitive display 118 is in a landscape orientation and information is displayed in the landscape orientation. For example, selectable features 702 are displayed. The predetermined area 202 is a band that extends along the edge 204 that is closest to the navigation device 140. A touch is first detected at the origin on the touch-sensitive display 118 illustrated by the ellipse 706. The touch is associated with the predetermined area 202 and all touch data associated with the touch is disregarded.

The method of filtering described with reference to FIG. 3 may be turned on and off, for example, based on the information displayed on the touch-sensitive display 118, the current application, and so forth. For example, filtering may be turned off when information that is not scrollable is displayed on the touch-sensitive display 118. Filtering may also be turned off when a keyboard is displayed to facilitate selection of keys of the keyboard. Each application may control the filtering such that filtering may be turned on or off by the application associated with the information displayed on the touch-sensitive display 118. Optionally, the user may be provided with a selectable option to turn on or off filtering.

In the example illustrated in FIG. 8, a keyboard 802 is displayed on the touch-sensitive display 118. When the keyboard 802 is displayed the touch-sensitive display 118, filtering is turned off. The touch illustrated by the ellipse 806 is processed, and the “space” key 804 is selected, even though the ellipse 806 would be associated with the predetermined area, such as the predetermined area 202 of FIG. 5 when filtering is turned on.

Another example of a portable electronic device 900 is illustrated in FIG. 9. In the example illustrated in FIG. 9, the portable electronic device 900 includes a physical keyboard 902, a touch-sensitive display 918, which may operate similarly to and have similar components as touch-sensitive display 118, and a navigation device 940 between the keyboard 902 and the touch-sensitive display 918. A touch that is first detected in the predetermined area 908 and all touch data associated with the touch are disregarded. In the example illustrated in FIG. 9, the predetermined area 908 does not extend across the entire touch-sensitive display 118 and is shown centered above the navigation device 940.

A touch-sensitive display that is located close to a navigation device may be inadvertently touched during use of the navigation device, and the navigation device may be inadvertently touched during use of the touch-sensitive display. Performing functions in response to inadvertent touches may result in corrective action that utilizes further device time and additional power, and may result in user frustration or dissatisfaction. Filtering, such as described above, based on touch location may reduce device use time, reduce power requirements, and improve the user interface. Processing of touch data is not delayed until further touch data is received because processing begins when the touch is first detected on the touch-sensitive display. Processing of touch data is more responsive with the filtering method described because unnecessary delays are not introduced in order to begin processing the touch data.

A method includes detecting a touch beginning at a first location on a touch-sensitive display of a portable electronic device, wherein the touch-sensitive display has a first area and second area. The method also includes, when the touch begins, filtering touch data comprising further processing the touch data when the first location is associated with the first area, and disregarding the touch data associated with the touch when the first location is associated with the second area.

A portable electronic device includes a touch-sensitive display, a navigation device, and a processor. The processor is operably coupled to the touch-sensitive display to detect a touch beginning at a first location on the touch-sensitive display, wherein the touch-sensitive display has a first area and second area, and when the touch begins, filter touch data by further processing the touch data when the first location is associated with the first area, and disregarding the touch data associated with the touch when the first location is associated with the second area.

A method includes detecting a touch beginning at a first location on a touch-sensitive display of a portable electronic device, determining when the first location is associated with a predetermined area of the touch-sensitive display, and when the touch is associated with the predetermined area, disregarding the touch data associated with the touch.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method comprising:
detecting a touch beginning at a first location on a touch-sensitive display of a portable electronic device, wherein the touch-sensitive display has a first area and second area;
when the touch begins, filtering touch data comprising:
further processing the touch data when the first location is associated with the first area; and
disregarding the touch data associated with the touch when the first location is associated with the second area.

2. The method according to claim 1, wherein further processing comprises reporting the touch to an application layer.

3. The method according to claim 1, wherein the first location comprises the first detected touch location.

4. The method according to claim 1, wherein disregarding the touch data comprises a disregarding the first detected touch location and all subsequent data associated with the touch.

5. The method according to claim 1, wherein filtering is discontinued when a keyboard is displayed on the touch-sensitive display.

6. The method according to claim 1, wherein filtering is controlled by an application associated with information displayed on the touch-sensitive display.

7. The method according to claim 1, wherein the second area comprises an area near a navigation device of the portable electronic device.

8. The method according to claim 1, wherein the second area comprises an area along an edge of the touch-sensitive display, which edge is near a navigation device of the portable electronic device.

9. The method according to claim 1, wherein the second area comprises an area that extends a distance of less than 10 pixels from an edge of the touch-sensitive display.

10. The method according to claim 1, wherein the first area and the second area cover a face of the touch-sensitive display.

11. The method according to claim 1, wherein the second area extends at least partially over a non-display area of the touch-sensitive display.

12. The method according to claim 1, wherein the second area is adjacent a single edge of the touch-sensitive display.

13. The method according to claim 1, wherein the size of the second area is related to the distance from the navigation device to the touch-sensitive display.

14. A computer-readable medium having computer-readable code executable by at least one processor of a portable electronic device to perform the method according to claim 1.

15. A portable electronic device comprising:
a touch-sensitive display;
a navigation device;
a processor operably coupled to the touch-sensitive display to detect a touch beginning at a first location on the touch-sensitive display, wherein the touch-sensitive display has a first area and second area, and when the touch begins, filter touch data by further processing the touch data when the first location is associated with the first area, and disregarding the touch data associated with the touch when the first location is associated with the second area.

16. The electronic device according to claim 15, wherein the first location comprises the first detected touch location.

17. The electronic device according to claim 15, wherein the second area is along an edge of the touch-sensitive display, which edge is near the navigation device.

18. The electronic device according to claim 15, wherein the second area extends over at least a portion of a non-display area of the touch-sensitive display.

19. The electronic device according to claim 15, wherein touch data that is disregarded comprises a first detected touch location and subsequently received data associated with the touch.

20. A method comprising:
detecting a touch beginning at a first location on a touch-sensitive display of a portable electronic device;
determining when the first location is associated with a predetermined area of the touch-sensitive display;
when the touch is associated with the predetermined area, disregarding the touch data associated with the touch.
